(19) United States
(12) Patent Application Publication
(10) Pub. No.: US 2005/0183816 A1
(43) Pub. Date: Aug. 25, 2005

(54) Method for production of structural components from fiber composites

(76) Inventors: Karl-Heinz Ilzhoefer, Kirchheim (DE); Patrick Kim, Stuttgart (DE); Thomas Schuh, Waiblingen (DE); Ronald Verleg, Wolle (NL); Alfonsius Antonius Maria Harbers, Beek (NL); Geert Jan Albert Klumpermann, Hellendoom (NL)

Correspondence Address: PENDORF & CUTLIFF, 5111 MEMORIAL HIGHWAY, TAMPA, FL, 33634-7356, US

(21) Appl. No.: 11/022,094

(22) Filed: Dec. 23, 2004

(30) Foreign Application Priority Data
Dec. 23, 2003 (DE) 103 60 743.9-16

(51) Int. Cl. B32B 31/00

(52) U.S. Cl. 156/272.2; 264/320; 264/489

(57) ABSTRACT

The present invention concerns a method for production of structural components with complex geometry from fiber composites in which the method is divided into two independent chemical reactions, a first pre-cross-linking during preforming into a semi-finished product and final cross-linking during deformation to a final shape.

### BACKGROUND OF THE INVENTION

1. Field of the Invention

The present invention concerns a method for the production of structural components with complex geometry from fiber composites.

2. Related Art of the Invention

Because of their potentialities for use in light-weight designs, fiber composites (FC) are suited in particular for use in aviation, racing, in the energy generation field and in shipbuilding. In the automotive field high costs and limited capacity for large-volume production stand in the way of extensive use of FC, so that their use is largely restricted to niche vehicles in the high-performance range, for example, in Formula 1 vehicles.

Present production technology for the production of structural components from FC is generally based on methods like autoclave methods, coiling and RTM in which impregnation of the reinforcement fibers with the resin and curing occur in the same die. Relatively long cycle times because of the long occupation times of the dies are the result, and this significantly increases the cost of the method.

In contrast to this, there are methods that can yield larger production volumes with respect to their better economic efficiency, like pultrusion (continuous deep drawing) or hot pressing, but these are restricted in terms of attainable geometries of the structural components. At present, mostly straight profiles with a constant cross-section can be produced, for example, during pultrusion. In addition, it is not possible to produce hollow profiles without additional joining steps.

In addition, the problem of precise control of orientation of fiber reinforcement of fiber composites occurs in such methods and avoidance of the fiber waviness in curved areas of the components is difficult to achieve.

Regarding vehicle construction, structural components are often characterized by the fact that they have complex geometries, which in turn, due to design engineering and installation or fitting methods, have sites with—often locally limited—high stress.

On the other hand, in vehicle series production there is a demand for high-volume methods, i.e., large series processes with short cycle times, since economic efficiency is paramount. On the one hand, this means efficient employment of materials, which must be equitably distributed considering stress and loads and, on the other hand, cost-effective processes with either a reduced number of process steps or with significantly increased throughput or reduced cycle time.

### SUMMARY OF THE INVENTION

With this as point of departure, the task of the present invention is to provide a method for the production of structural components with complex geometry from fiber composites, which is consistent and permits production of components with complex geometries in a short time with high quality.

### BRIEF DESCRIPTION OF THE INVENTION

This task is solved with the method for production of structural components with complex geometries from fiber composites comprising the following steps:
impregnation of a fiber structure with a thermosetting plastic resin to form a fiber composite;
formation of the fiber composite into a deformable semi-finished product;
optional rapid cooling of the fiber composite during preforming below a specific temperature at which cross-linking of the resin is stopped; and
deformation of the semi-finished product to a final configuration and final cross-linking of the resin. This can optionally occur with heating of the semi-finished product above a specific temperature at which cross-linking is activated.

### DETAILED DESCRIPTION OF THE INVENTION

The method according to the invention is therefore characterized by two independent deformation steps accompanied by two independently-running chemical reaction steps. The first step includes impregnation and preforming of the fiber composite into a semi-finished product and rapid cooling of the semi-finished product coupled therewith. Because of this, the already-occurring cross-linking of the thermosetting resin is abruptly stopped. This process is generally referred to as “B-staging”.

The semi-finished product, then present in almost a pre-cross-linked state, is characterized by good intrinsic rigidity and can consequently be stored over a long period at room temperature. Since the semi-finished product is not tacky, easy handling is made possible.

In the second independent step, the semi-finished product (or several semi-finished products simultaneously) are deformed in a separate die to the final configuration of the structural component in which heating above a specific temperature occurs during deformation so that final cross-linking of the thermosetting resin and its curing to the final geometry can be accomplished.

It is clear that with the method according to the invention the cycle times and die occupation times can be substantially reduced for production of such complex components.

So-called “B-staging” permits production of semi-finished products with high fiber content, during which structuring and fiber reinforcement can be produced “in-line” with impregnation and consolidation so that a high degree of reinforcement of the semi-finished products is possible, which effectively increases the use possibilities of FC in light vehicle construction. Moreover, semi-finished products with low pore density are produced by the first step so that high component quality overall can be achieved. Better control with respect to orientation and structure of the fiber reinforcement accompanies this.

The fiber reinforcements can be provided, for example, as ordinary unidirectional fiber strands, as fiber fabric or a fiber mesh, wherein the latter is preferred because of the good shapeability.

The step of preforming can include, for example, continuous deep drawing (pultrusion), calendering or double-band pressing. There can be achieved, on the one hand, flat profiles or profiles with complex cross-sections, for example Y-, T- or H-shaped cross-sections, or on the other hand, hollow profiles for subsequent production of hollow bodies, for example, by internal high-pressure deformation.

In the second step of deformation to the final configuration, deep drawing, pressing or internal high pressure deformation or any combination of these methods are used. Curing by heating above a specific temperature during deformation can occur according to the invention either by heating the deformation die or by using UV radiation or microwave radiation.

Fiber waviness can be reduced by subsequent deformation so that the semi-finished profile is inserted separately, optionally pre-curved or pre-deformed, into the deformation die, and in the case of insertion of several profiles, allowing for relative movement among the profiles.

In a particularly preferred variant of the method according to the invention, the step of final deformation includes insertion of at least two semi-finished products into the deformation die and joining of the at least two semi-finished products during deformation into a component. On the one hand, complex geometries with strongly curved lines can be achieved in this case while preventing fiber waviness. On the other hand, an additional joining step after deformation is unnecessary so that the cycle time is further reduced. By combining the already-mentioned methods of the second step, a combination of hollow and flat component sections can also be achieved in one component.

Joining then occurs either by the adhesion of the resin directly between the two semi-finished products, which then adhere to each other and are cured to each other, or an additional adhesion promoter or adhesive is introduced between the two semi-finished products in order to support adhesion to each other.

In a further embodiment of the invention, a so-called hybrid resin is used as resin, which is based on at least two generally independent reaction systems. The reaction system can be based, for example, on polyurethane and vinyl esters. The second reaction system, however, can also be in the form of a so-called accelerator or catalyst of the first reaction system through which control of the reaction can occur.

In this case, during or after performing, a first cross-linking is carried out through the first reaction system. This cross-linking imparts, to a certain extent, strength and handling capability of the semi-finished product. By deliberate choice of the first reaction system the optional process step of cooling can be dispensed with so as not to interrupt cross-linking. Subsequent cross-linking then occurs during or after final deformation by cross-linking of the second reaction system. For this purpose the semi-finished product/component can optionally be heated to a reaction temperature. On the other hand, the second reaction system can also be activated by other ordinary activation measures.

1. A method for the production of structural components with complex geometry from fiber composites, comprising the steps of:
impregnating a fiber structure with a thermosetting plastic resin to form a fiber composite;
preforming the fiber composite to a semi-finished product;
carrying out a partial cross-linking of the resin;
deforming the semi-finished product into a final shape; and
final cross-linking the resin.

2. The method according to claim 1, wherein the fiber composite, during performing, is cooled below a specific temperature at which cross-linking of the resin is stopped.

3. The method according to claim 1, wherein deformation of the semi-finished product occurs above a specific temperature at which final cross-linking of the resin occurs.

4. The method according to claim 1, wherein the fiber structure is unidirectional fiber strands, a fiber fabric or fiber mesh.

5. The method according to claim 1, wherein the step of performing involves continuous deep drawing (pultrusion), calendering or pressing.

6. The method according to claim 1, wherein the step of deformation involves occurs by deep drawing, pressing or internal high-pressure deformation.

7. The method according to claim 1, wherein the step of deformation also includes:
insertion of at least two semi-finished products into a die; and
joining the at least two semi-finished products during deformation into a component.

8. The method according to claim 7, wherein joining occurs exclusively by adhesion of the resin.

9. The method according to claim 7, wherein joining is supported by using an adhesion promoter or adhesive.

10. The method according to claim 1, wherein heating occurs during deformation by UV or microwave radiation.

11. The method according to claim 1, wherein the resin is a hybrid resin and has at least first and second reaction systems.

12. The method according to claim 11, wherein cross-linking of the resin is interrupted during or after preforming of the semi-finished product after cross-linking of the first reaction system.

13. The method according to claim 11, wherein final cross-linking of the resin occurs by cross-linking of the second reaction system.
